(19) United States
(12) Patent Application Publication
(10) Pub. No.: US 2007/0199742 A1
(43) Pub. Date: Aug. 30, 2007

(54) Vehicle Power Unit Support Structure

(76) Inventors: Tetsuya Miyahara, Saitama (JP); Shuji Otake, Saitama (JP); Tatsuhide Sakai, Saitama (JP); Masafumi Kyuse, Saitama (JP)

Correspondence Address: CARRIER BLACKMAN AND ASSOCIATES, 24101 NOVI ROAD, SUITE 100, NOVI, MI, 48375, US

(21) Appl. No.: 11/547,828

(22) PCT Filed: Dec. 27, 2005
(86) PCT No.: PCT/JP05/24246

§ 371 Date: Oct. 6, 2006

(30) Foreign Application Priority Data
Dec. 28, 2004 (JP) 2004-381488

(51) Int. Cl. B60K 7/00; B60K 17/00

(52) U.S. Cl. 180/58; 180/374

(57) ABSTRACT

A vehicle power unit support structure supports a transversal-type power unit having a power source and transmission coupled with each other in a juxtaposed relation in a width direction of the vehicle. The power unit support structure includes a power source mount provided on an end portion of the power source, and a transmission mount disposed on an end portion of the transmission. As viewed from the front of the vehicle, respective spring axis lines of the power source mount and transmission mount are inclined to intersect with each other at a point higher than the center of gravity of the power unit.

### TECHNICAL FIELD

The present invention relates to a vehicle power unit structure for mounting, on a vehicle body, a transversal-type power unit where the output shaft of an engine employed as a power source is disposed in a transverse or width direction of the vehicle.

### BACKGROUND ART

Power units of ordinary vehicles are broadly classifiable into a longitudinal (i.e., longitudinally-mounted) type and a transversal (i.e., transversely-mounted) type. In the longitudinal-type power units, the power source and transmission are coupled with each other in a row in a longitudinal or forward/rearward direction of the vehicle.

In the transversal-type power units, on the other hand, the power source and transmission are coupled with each other in a juxtaposed relation in a transverse or leftward/rightward direction of the vehicle. For example, in the transversal-type power units, the crankshaft of the engine extends in the width direction of the vehicle, and the input shaft of a transmission, employed as the transmission, is connected to the distal end of the crankshaft. Generally, the transversal-type power units are each accommodated in a power unit space (e.g., engine room), and thus, the power unit space can have a reduced length in the forward/rearward direction.

One example of a vehicle power unit support structure for mounting such a transversal-type power unit is proposed in JP-A-2004-148843. This proposed power unit support structure will be described below with reference to FIGS. 10A and 10B hereof. FIG. 10A is a plan view of the power unit support structure, and FIG. 10B is a rear view of the power unit support structure.

The conventional power unit support structure 200 of FIGS. 10A and 10B mounts, on a vehicle body 205 via a subframe 204, a transversal-type power unit 203 having an engine 201 and a transmission 202 coupled with each other in a juxtaposed relation in the transverse direction of the vehicle.

More specifically, the power unit support structure 200 supports a static load of the power unit 203 by means of a front mount 212, rear mount 213 and lower trans-mount (not shown) fixed to the subframe 204 beneath the center of gravity 211 of the engine 201.

The power unit 203 is also supported by left and right mounts (i.e., side engine mounted 214 and upper trans-mount 215) fixed to the vehicle body 205 above the center of gravity 211 of the engine 201.

The operating stability and riding comfort of the vehicle can not be enhanced by merely restraining vibration of the power unit 203 from being transmitted to the vehicle body 205. In order to enhance the operating stability and riding comfort of the vehicle, it is also necessary to prevent the behavior of the power unit 203 from influencing the vehicle body 205. For example, as the vehicle 200 is turned to the left or right, a centrifugal force acts on the vehicle 200 being turned. During that time, inertia makes the power unit 203 stay in place. In order to sufficiently enhance the operating stability and riding comfort of the vehicle 200, it is preferable to appropriately restrain the behavior of the power unit 203 from influencing the vehicle body 205.

As stated above, it is preferable to enhance the operating stability and riding comfort of the vehicle by restraining the behavior of the power unit from influencing the vehicle body.

### DISCLOSURE OF THE INVENTION

According to an aspect of the present invention, there is provided an improved vehicle power unit support structure, which comprises: a transversal-type power unit accommodated in a power unit space and having a power source and transmission coupled with each other in a juxtaposed relation in a width direction of the vehicle; static-load-supporting mounts disposed lower than a center of gravity of the power unit and supporting the power unit; a power source mount disposed on an end portion of the power source remote from the transmission; and a transmission mount disposed on an end portion of the transmission remote from the power source. As viewed from the front of the vehicle provided with the support structure of the invention, both a spring axis line of the power source mount and a spring axis line of the transmission mount are inclined to intersect with each other at a point higher than the center of gravity of the power unit.

With the aforementioned inventive arrangements, the center of composite resiliency of the static-load-supporting mounts, power source mount and transmission mount is shifted upward to substantially coincide with the center of gravity of the power unit. Thus, when the vehicle turns to the left or right, for example, a moment resulting from an inertial force of the power unit hardly moves, so that the power unit is displaced only in a generally horizontal direction without making substantial rolling movement. As a consequence, it is possible to restrain the behavior of the heavy transversal-type power unit from influencing the vehicle body during travel of the vehicle. Thus, the inventive arrangements can enhance the operating stability and riding comfort of the vehicle. Further, in setting the center of composite resiliency of all of the mounts at an optimal height, the supporting heights of the power source mount and transmission mount can be set relatively freely, with the result that the design freedom of the vehicle can be enhanced significantly. By the provision of such static-load-supporting mounts, power source mount and transmission mount, vibration produced from the transversal-type power unit can be effectively restrained from being transmitted to the vehicle body.

According to another aspect of the present invention, there is provided an improved vehicle power unit support structure, which comprises: a transversal-type power unit accommodated in a power unit space and having a power source and a transmission coupled with each other in a juxtaposed relation in a width direction of the vehicle; static-load-supporting mounts disposed lower than the center of gravity of the power unit and supporting the power unit; a power source mount disposed on an end portion of the power source remote from the transmission; and a transmission mount disposed on an end portion of the transmission remote from the power source. As viewed from the front of the vehicle, both a damping axis line of the power source mount and an damping axis line of the transmission mount are inclined to intersect with each other at a point higher than the center of gravity of the power unit.

With the damping axis lines of the power source mount and transmission mount inclined to intersect with each other at a point higher than the center of gravity of the power unit, the power source mount and transmission mount can effectively perform attenuating functions not only in the upward/downward or vertical direction but also in the leftward/rightward or horizontal direction.

Thus, when the vehicle turns to the left or right, for example, a moment resulting from an inertial force of the power unit can be attenuated by the above-mentioned leftward/rightward or horizontal attenuating function, and the power unit is hardly displaced in the horizontal direction without making substantial rolling movement. As a consequence, it is possible to restrain the behavior of the heavy transversal-type power unit from influencing the vehicle body during travel of the vehicle. Thus, the inventive arrangements can enhance the operating stability and riding comfort of the vehicle. Further, in setting the center of composite resiliency and attenuation of all of the mounts at an optimal height, the supporting heights of the power source mount and transmission mount can be set with respect to the position of the center of gravity relatively freely, with the result that the design freedom of the vehicle can be enhanced significantly. By the provision of such static-load-supporting mounts, power source mount and transmission mount, vibration produced from the transversal-type power unit can be effectively restrained from being transmitted to the vehicle body.

According to still another aspect of the present invention, there is provided an improved vehicle power unit support structure, which comprises: a transversal-type power unit accommodated in a power unit space and having a power source and a transmission coupled with each other in a juxtaposed relation in a width direction of the vehicle; static-load-supporting mounts disposed lower than the center of gravity of the power unit and supporting the power unit; a power source mount disposed on an end portion of the power source remote from the transmission; and a transmission mount disposed on an end portion of the transmission remote from the power source. The power source mount and the transmission mount each have a predetermined vertical damping axis line and a predetermined horizontal damping axis line perpendicular to the vertical damping axis line, and, as viewed from the front of the vehicle, the horizontal damping axis lines of the power source mount and the transmission mount are inclined with respect to a forward/rearward direction and width direction of the vehicle.

With the invention arranged in the aforementioned manner, it is possible to efficiently restrain loads (including vibration) in the forward/rearward direction and width direction of the power unit. Therefore, when the vehicle makes rolling movement, pitch motion or yaw motion, the invention can restrain the behavior of the heavy transversal-type power unit from influencing the vehicle body due to inertia. As a result, the present invention can even further enhance the operating stability and riding comfort of the vehicle. Furthermore, by the provision of such static-load-supporting mounts, power source mount and transmission mount, vibration produced from the transversal-type power unit can be effectively restrained from being transmitted to the vehicle body.

Further, as viewed from above the vehicle, the horizontal damping axis lines of the power source mount and the transmission mount are preferably inclined to intersect at a right angle with each other. Thus, it is possible to even more efficiently restrain loads (including vibration) in the forward/rearward direction and width direction of the power unit.

### BRIEF DESCRIPTION OF DRAWINGS

FIG. 1 is a front view showing front sections of a vehicle and power unit support structure of the present invention;

FIG. 2 is a plan view showing the front sections of the vehicle and power unit support structure of FIG. 1;

FIG. 3 is a perspective view of the power unit support structure shown in FIG. 2;

FIG. 4 is a sectional view of a power source mount shown in FIG. 3;

FIG. 5 is a sectional view taken along the 5-5 line of FIG. 4;

FIG. 6 is a schematic front view showing relationship between spring axis lines and between damping axis lines of the power source mount and transmission mount shown in FIG. 1;

FIG. 7 is a schematic plan view showing relationship between the damping axis lines of the power source mount and transmission mount shown in FIG. 2;

FIG. 8 is a schematic view showing a modification of the power unit support structure of the present invention, in which the power source mount and transmission mount are disposed lower than the center of gravity of the power unit;

FIGS. 9A and 9B are schematic views showing a comparative example and preferred embodiment of the power unit support structure; and

FIGS. 10A and 10B are plan and rear views, respectively, of a conventional power unit support structure.

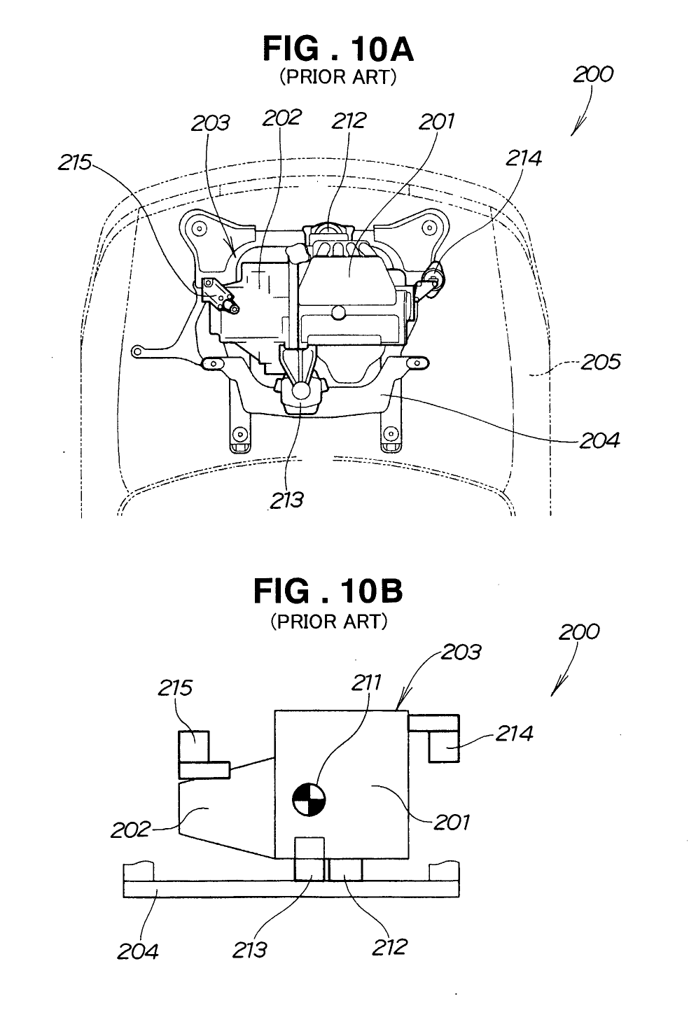

### BEST MODE FOR CARRYING OUT THE INVENTION

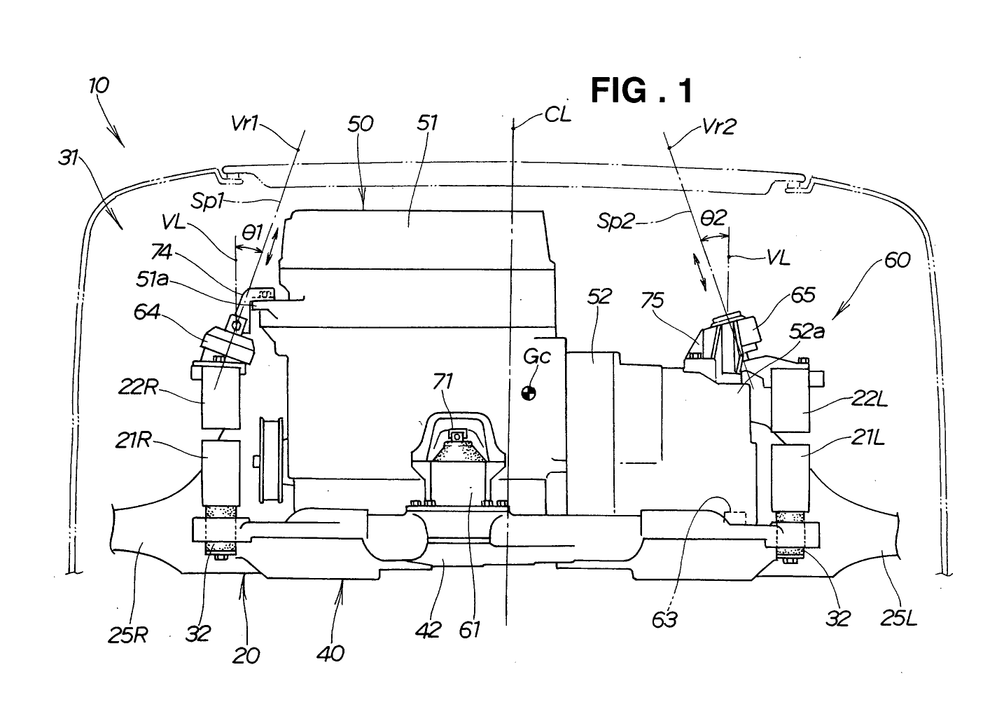

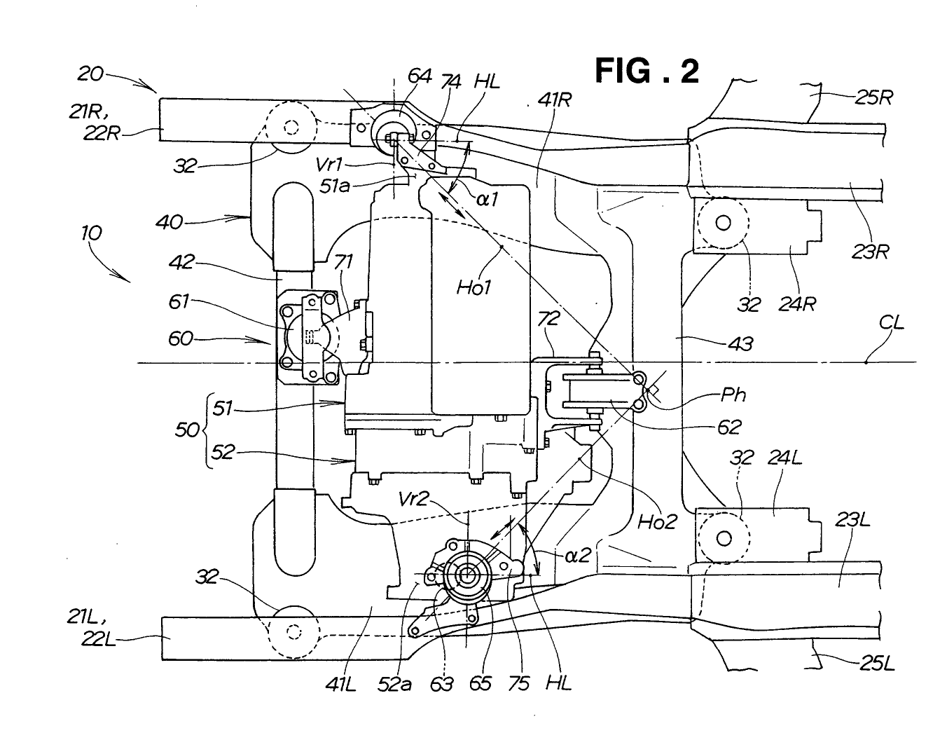

FIGS. 1 and 2 show a vehicle 10 to which is applied an embodiment of the present invention, and the vehicle 10 is a front-engine/front-drive vehicle where front road wheels are driven via an engine 51 provided on a front portion of a vehicle body 20. However, the vehicle 10, to which is applied the embodiment of the present invention, may be a front-engine/rear-drive vehicle where rear road wheels are driven via the engine 51, or a four-wheel drive vehicle where the front and rear road wheels are driven. The vehicle 10 includes a power unit 50 accommodated in a power unit space (e.g., engine space) 31 disposed in a front portion of the vehicle body 20.

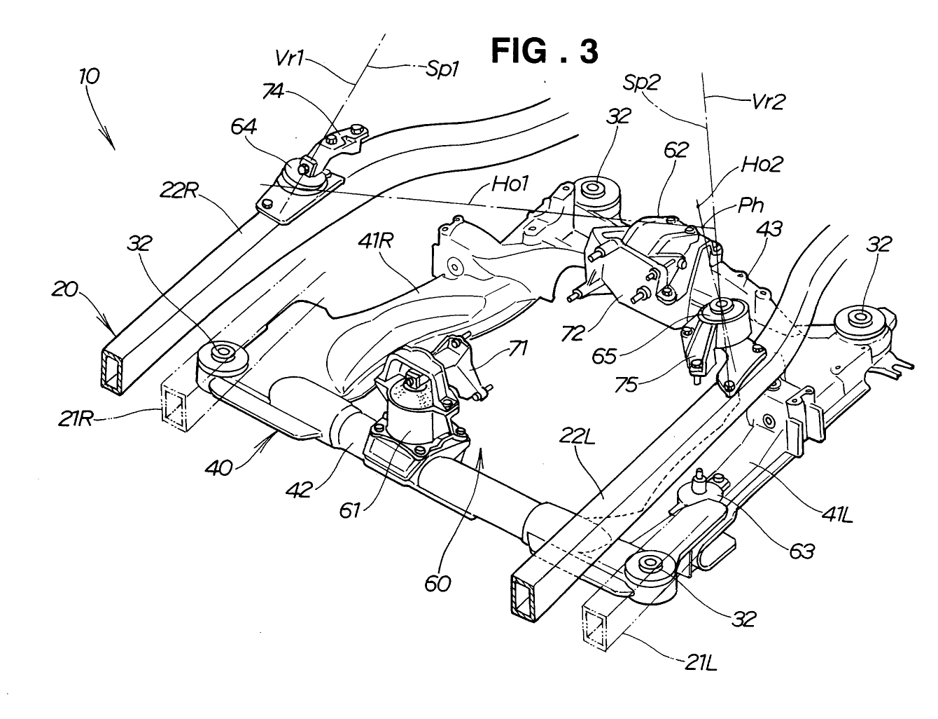

Referring to FIGS. 1-3, the vehicle body 20 includes left and right front side frames 21L and 21R extending in the longitudinal or forward/rearward direction of the body 20, left and right upper frames 22L and 22R extending in the forward/rearward direction of the body 20 above the left and right front side frames 21L and 21R, and left and right floor frames 23L and 23R extending rearwardly from the rear ends of the left and right front side frames 21L and 21R.

The left and right front side frames 21L and 21R include left and right brackets 24L and 24R (FIG. 2) on their respective rear inner surfaces. Reference numerals 25L and 25R indicate left and right outriggers.

Front subframe 40 is dangled, via four, i.e. front, rear, left and right, vibration-preventing resilient bushes 32, from front portions of the left and right front side frames 21L and 21R and left and right brackets 24L and 24R.

The front subframe 40 is a rectangular frame, which includes left and right side members 41L and 41R, front member 42 secured to and connecting between front end portions of the left and right side members 41L and 41R, and rear member 43 secured to and connecting between rear end portions of the left and right side members 41L and 41R.

Front suspension and steering gear box (not shown) are mounted on the front subframe 40. Because such a front subframe 40 is part of the vehicle body 20, the terms “vehicle body 20” should be construed herein as embracing the front subframe 40, unless otherwise stated.

The power unit 50, shown in FIGS. 1 and 2, is a transversal-type power unit which includes the engine 51 and transmission 52 coupled with each other in a juxtaposed relation in the transverse direction of the vehicle 10. The engine 51 is a power source having its output shaft extending in the transverse direction of the vehicle 10. The transmission 52 has an input shaft connected to the output shaft of the engine 51 via a clutch etc.

The transversal-type power unit 50 is mounted on the vehicle body 20 via a power unit support structure 60 according to the embodiment of the present invention.

The power unit support structure 60 includes: a front mount 61 provided on a front end portion of the power source 51; a rear mount 62 provided on a rear end portion of the power source 51; a transmission-side lower mount 63 provided on a left lower portion of the transmission 52; a power source mount 64 provided on a right side end portion of the power source 51; and a transmission mount 65 provided on a left upper end portion of the transmission 52.

The above-mentioned front mount 61, rear mount 62 and transmission-side lower mount 63 are each positioned lower than the center of gravity Gc (see FIG. 1) of the power unit 50, so as to function as mounts for supporting a static load, i.e. weight, of the power unit 50.

The power source mount 64 and transmission mount 65 are positioned higher than the center of gravity Gc (see FIG. 1) of the power unit 50 and do not, or almost do not support, the static load of the power unit 50. More specifically, the power source mount 64 is a support member provided on a side portion 51a of the engine 51 opposite from or remote from the transmission 52. The transmission mount 65 is a support member provided on a side portion 52a of the transmission 52 opposite from or remote from the engine 51.

The front mount 61 is located close to the longitudinal centerline CL extending centrally through the width of the vehicle 10 and has a lower end portion connected to the front member 42 of the front subframe 40, so as to support a front lower portion of the engine 51 via an engine bracket 71. The front mount 61 is, for example, in the form of a one-way liquid seal engine mount.

The rear mount 62 is located close to the longitudinal centerline CL extending centrally through the width of the vehicle 10 and has a lower end portion connected to the rear member 43 of the front subframe 40, so as to support a rear lower portion of the engine 43 via an engine bracket 72. The rear mount 62 is, for example, in the form of a rubber mount.

The transmission-side lower mount 63 has a lower end portion connected to the side member 41L of the front subframe 40, so as to support a left lower portion of the transmission 52 via a transmission bracket (not shown). The transmission-side lower mount 63 is, for example, in the form of a rubber mount.

The power source mount 64 has a lower end portion connected to the right upper frame 22R so as to support the right upper portion 51a of the engine 51 (i.e., side portion 51a of the engine 51 opposite from the transmission 52) via an engine bracket 74.

The transmission mount 65 has a lower end portion connected to the left upper frame 22L so as to support the left upper portion 52a of the engine 51 (i.e., side portion 52a of the transmission 52 opposite from the engine 51) via a transmission bracket 75.

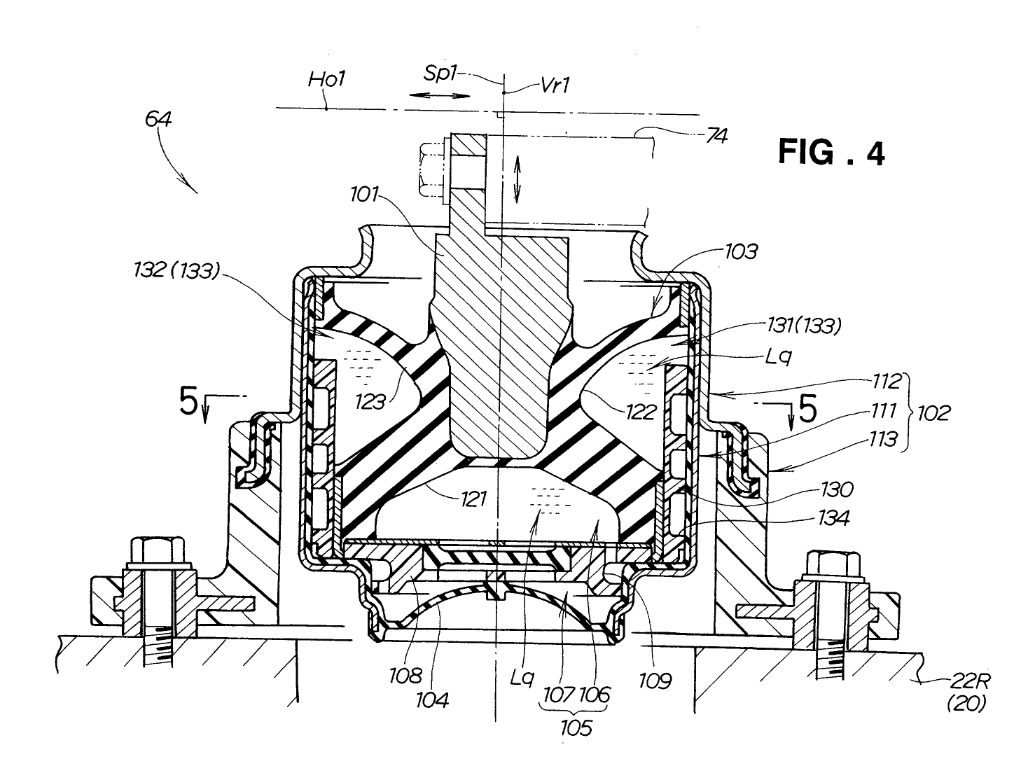

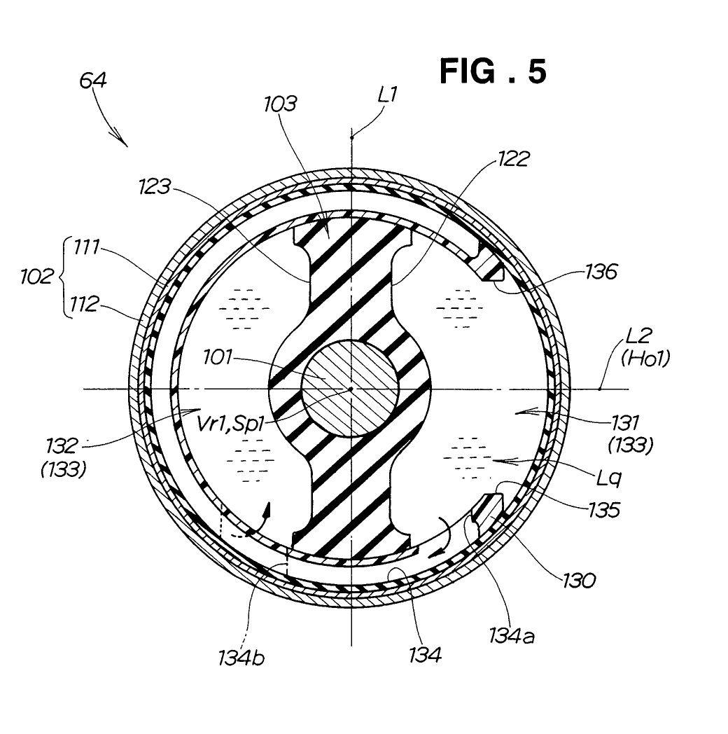

Next, a description will be given about a detailed construction of the power source mount 64, with reference to FIGS. 4 and 5.

Referring to FIGS. 4 and 5, the power source mount 64 is a vibration-preventing mechanism which is disposed between the vehicle body 20 and the engine 51 (see FIG. 1) and supports the engine 51 while preventing vibration from being transmitted from the engine 51 to the vehicle body 20, and this power source mount 64 functions as a two-way liquid seal mount. Thus, the power source mount 64 has a vertical spring axis line Sp1 and damping axis line Vr1, as well as a horizontal damping axis line Ho1 perpendicular to the vertical damping axis line Vr1.

The power source mount 64 includes a first mounting member 101 connected to the engine 51; a cylindrical second mounting member 102 connected to the vehicle body 20; a resilient member 103 connecting between the first and second mounting members 101 and 102; a diaphragm 104 fixed to the second mounting member 102 remotely from the resilient member 103; a first liquid chamber 105 partitioned by the resilient member 103 and diaphragm 104; a partition member 108 that partitions the first liquid chamber 105 into a main liquid chamber 106 adjacent to the resilient member 103 and an auxiliary liquid chamber 107 adjacent to the diaphragm 104. The partition member 108 is fixed to the second mounting member 102.

The first mounting member 101, second mounting member 102, resilient member 103, diaphragm 104, first liquid chamber 105 and partition member 108 are each provided about the vertical damping axis line Vr1 in the power source mount 64. Actuating liquid Lq is enclosed in the main and auxiliary liquid chambers 106 and 107.

The first mounting member 101 is a metal member secured via the engine bracket 74 to the engine 51.

The second mounting member 102 includes: a metal cylindrical member 111 to which the resilient member 103 is connected; a metal bracket 112 having the metal cylindrical member 111 pressed therein; and a resin-made bracket 113 supporting the metal bracket 112 and secured to the vehicle body 20.

The resilient member 103 is in the form of a rubber block that can resiliently deform to absorb vibration transmitted from the first mounting member 101 to the second mounting member 102. The first mounting member 101 has a generally columnar shape.

The resilient member 103 has a lower cavity portion 121 greatly opening downward from a lower end surface portion thereof, and a pair of first and second cavity portions 122 and 123 greatly opening laterally from opposite side surface portions thereof.

As illustrated in FIG. 5, a first line L1 is a linear line passing the axial center line Vr1 (i.e., vertical damping axis line Vr1) of the resilient member 103, and a second line L2 is a linear line passing the axial centerline Vr1 and intersecting at a right angle with the first line L1 and passing the axial centerline Vr1. The first and second cavity portions 122 and 123 are horizontally symmetrical to each other about the first line L1.

The second line L2 is an damping axis line intersecting at a right angle with the vertical damping axis line Vr1. Hereinafter, the second line L2 will also be referred to as “damping axis line Ho1 perpendicular to the vertical damping axis line Vr1”, as appropriate.

As illustrated in FIG. 4, the diaphragm 104 closes a lower end opening of the metal cylindrical member 111 (adjacent to the vehicle body 20), and it is curved to bulge toward the partition member 108. The diaphragm 104 is made of a resilient material, such as a film-shaped rubber material, and displaceable in the axial direction of the power source mount 64.

The partition member 108 is a disk-shaped member having a communicating passage 109 formed in it outer peripheral surface. The main liquid chamber 106 is in communication with the auxiliary liquid chamber 107 via the communicating passage 109. Hereinafter, the communicating passage 109 will be referred to as “first office 109”.

As shown in FIGS. 4 and 5, the resilient member 103, diaphragm 104, partition member 108 and side partition member 130 are incorporated in the metal cylindrical member 111.

The resilient member 103 is fitted in the side partition member 130. The auxiliary chamber 133 comprises first and second side liquid chamber sections 131 and 132. The first side liquid chamber 131 is defined by the side partition member 130 and first side concave portion 122. The second side liquid chamber 132 is defined by the side partition member 130 and second side concave portion 123. The second liquid chamber 133 is a space for enclosing the actuating liquid Lq.

The side partition member 130, as shown in FIG. 5, has a generally C shape, which has a labyrinth-like communicating passage 134. The first and second side liquid chamber sections 131 and 132 are in communication with each other via the communicating passage 134. Hereinafter, the above-mentioned communicating passage 134 will be referred to as “second orifice 134”.

Further, in FIG. 5, the second orifice 134 has one end 134a formed as a through-hole that communicates at its inner side (upper side in the figure) with the first side liquid chamber section 131 near one recessed end 135 of the C-shaped side partition member 130. The second orifice 134 has another end 134b formed as a through-hole that communicates with the second side liquid chamber section 132 at a position located diagonally beneath the one end 134a of the side partition member 130.

Further, as seen in FIG. 5, the second orifice 134 extends arcuately clockwise (as viewed in plan) from the one end 134a along the outer peripheral surface of the side partition member 130 and then extends downward near another recessed end 136 of the side partition member 130. Then, the second orifice 134 extends arcuately counterclockwise (as viewed in plan) back toward the one recessed end 135 while curving slightly upward on its way and ultimately leads to the other end 134b. The one end 134a communicates with the first side concave portion 122, while the other end 134b communicates with the second side concave portion 123.

The following paragraphs describe vibration-attenuating action of the power source mount 64.

Referring back to FIG. 4, as vibration acts on the power source mount 64 from the engine 51 (FIG. 1) in the axial direction (i.e., direction of the axial centerline or vertical damping axis line Vr1), the actuating liquid Lq passes between the main and auxiliary chambers 106 and 107 through the first orifice 109 and the resilient member 103 deforms resiliently, so as to attenuate the vibration.

As vibration and load acts on the power source mount 64 from the engine 51 in the direction of the horizontal damping axis line Ho1 perpendicular to the vertical damping axis line Vr1, the actuating liquid Lq passes between the first and second side liquid chambers 131 and 132 through the second orifice 103 and the resilient member 103 deforms resiliently, so as to attenuate the vibration and load.

Next, a description will be given about positional relationship between the power source mount 64 and the transmission mount 65 constructed in the aforementioned manner.

As shown in FIGS. 1-3, the transmission mount 65 is substantially similar in construction to the power source mount 64, but oriented vertically opposite from the power source mount 64. Namely, the transmission mount 65 mounts the first mounting member 101 (FIG. 4) to the left upper frame 22L and mounts the second mounting member 102 (FIG. 4) to the transmission 52 via the transmission bracket 75.

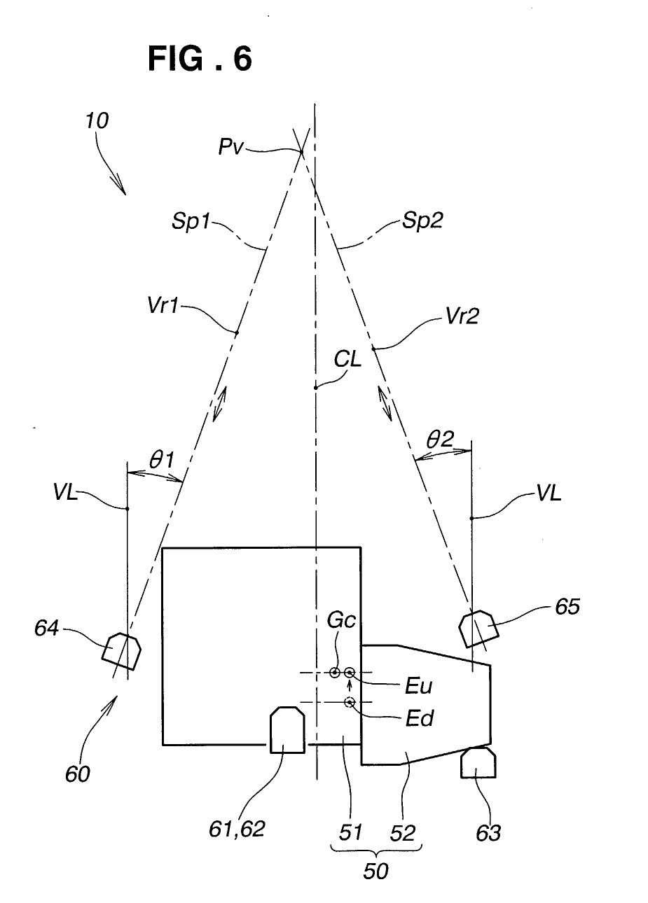

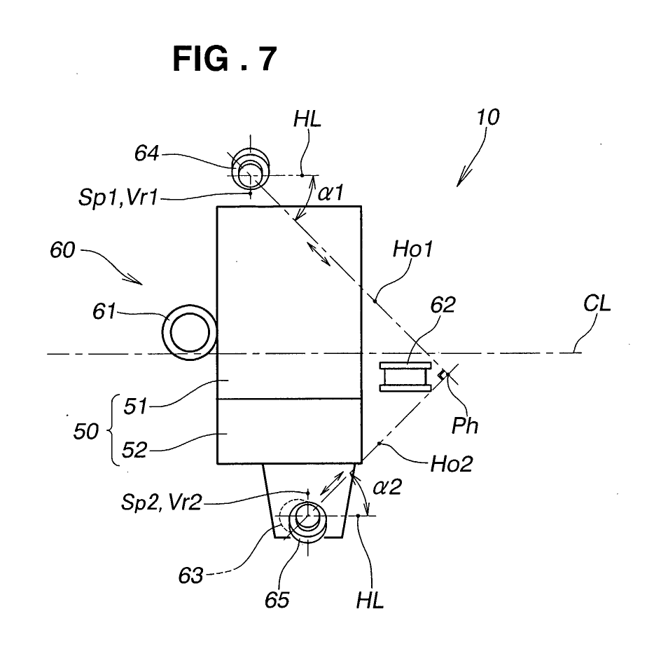

FIG. 6 is a schematic front view showing the vehicle power unit support structure of the present invention in correspondence with FIG. 1, and FIG. 7 is a schematic view showing the vehicle power unit support structure in correspondence with FIG. 2.

As set forth above and as seen from FIGS. 6 and 7, the power source mount 64 has the vertical spring axis line (resilient axis line) Sp1. The power source mount 64 also has the vertical damping axis line Vr1, and the horizontal damping axis line Ho1 perpendicular to the vertical damping axis line Vr1.

The transmission mount 65 too has the vertical spring axis line (resilient axis line) Sp2, vertical damping axis line Vr2, and horizontal damping axis line Ho2 perpendicular to the vertical damping axis line Vr2.

The vertical spring axis line Sp2 of the transmission mount 65 corresponds to the vertical spring axis line Sp1 of the power source mount 64.

Further, the vertical damping axis line Vr2 of the transmission mount 65 corresponds to the vertical damping axis line Vr1 of the power source mount 64. Furthermore, the horizontal damping axis line Ho2 of the transmission mount 65 corresponds to the horizontal damping axis line Ho1 of the power source mount 64.

In the present invention, the damping axis lines Vr1, Vr2 and Ho1, Ho2 are axis lines extending in respective attenuating directions of the mounts 64 and 65.

The spring axis lines (resilient axis lines) Sp1 and Sp2 are axis lines (centerlines) in respective directions of resiliency of the mounts 64 and 65. Namely, directions of loads applied to the mounts 64 and 65 and the directions of resiliency of the mounts 64 and 65 agree with each other, so that angular displacement can be avoided.

As seen in FIG. 6, i.e. as viewed from the front of the vehicle 10, the vertical spring axis line Sp1 of the power source mount 64 and the vertical spring axis line Sp2 of the transmission mount 65 are inclined to intersect with each other at a point higher than the center of gravity Gc of the power unit 50.

Similarly, the vertical damping axis line Vr1 of the power source mount 64 and the vertical damping axis line Vr2 of the transmission mount 65 are inclined to intersect with each other at a point higher than the center of gravity Gc of the power unit 50.

More specifically, the vertical damping axis line Vr1 of the power source mount 64 is inclined by an angle θ1 relative to a vertical or plumb line VL toward the longitudinal centerline CL, extending centrally through the width of the vehicle, to pass a point Pv above the vehicle body. The vertical damping axis line Vr2 of the transmission mount 65 is inclined by an angle θ2 relative to the vertical or plumb line VL toward the longitudinal centerline CL to pass the point Pv above the vehicle body. For example, the inclined angle θ1 of the vertical damping axis line Vr1 is identical to the vertical damping axis line Vr2 angle θ2. The point Pv is where the vertical damping axis lines Vr1 and Vr2 intersect with each other, and it is located higher than the center of gravity Gc of the power unit 50.

As shown in FIG. 7, i.e. as viewed from above the vehicle 10, the horizontal damping axis lines Ho1 and Ho2 are inclined with respect to the forward/rearward direction and width direction of the vehicle 10. As viewed from above the vehicle 10, the horizontal damping axis lines Ho1 and Ho2 are inclined to intersect at a right angle with each other.

More specifically, the horizontal damping axis line Ho1 of the power source mount 64 is inclined by an angle α1 relative to a horizontal line HL, parallel to the longitudinal centerline CL extending in the forward/rearward direction of the vehicle body, toward the longitudinal centerline CL and toward the rear of the vehicle body. Similarly, the horizontal damping axis line Ho2 of the transmission mount 65 is inclined by an angle α2 relative to the horizontal line HL toward the longitudinal centerline CL and toward the rear of the vehicle body. The horizontal damping axis lines Ho1 and Ho2 intersect with each other at a point Ph.

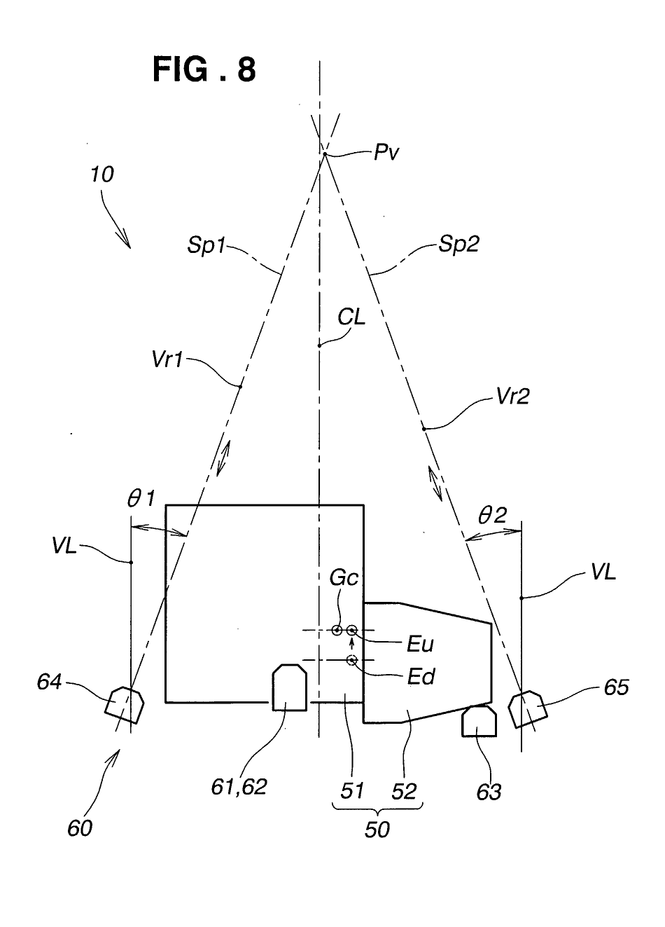

FIG. 8 schematically shows a modification of the vehicle power unit support structure of the present invention of FIG. 6.

As illustrated in FIG. 8, the modified vehicle power unit support structure 60 includes the power source mount 64 and transmission mount 65 located lower than the center of gravity Gc of the power unit structure 50.

In the modified vehicle power unit support structure 60 too, the vertical damping axis line Vr1 of the power source mount 64 and vertical damping axis line Vr2 of the transmission mount 65 slant to intersect with each other at a point higher than the center of gravity Gc of the power unit 50, as viewed from the front of the vehicle 10.

Other arrangements and elements of the modified vehicle power unit support structure 60 of FIG. 8 are similar to those in the vehicle power unit support structure of FIGS. 1-7, and they are indicated in FIG. 8 by the same reference characters as in FIG. 6. Thus, these other arrangements and elements will not be described to avoid unnecessary duplication.

The following paragraphs describe behavior of the power unit support structure 60.

Now, consider a comparative example where the vertical damping axis lines Vr1 and Vr2 are set to agree with the plumb line. In this example, a center of composite resiliency Ed of all of the mounts 61, 62, 63, 64 and 65 would be located lower than the center of gravity Gc of the power unit 50, as seen in FIGS. 6 and 8.

In the preferred embodiment of the present invention, on the other hand, the intersection point Pv where the vertical damping axis lines Vr1 and Vr2 intersect is located higher than the center of gravity Gc of the power unit 50, as shown in FIGS. 6 and 8. As a consequence, the center of resiliency, determined by only the power source mount 64 and transmission mount 65, agrees with the intersection point Pv, and thus, the center of composite resiliency Eu of all of the mounts 61-65 can be shifted upward from the center of composite resiliency Ed. Thus, the center of composite resiliency Eu can be set to substantially coincide with the center of gravity Gc of the power unit 50.

Particularly, in the illustrated example of FIG. 6, the power unit 50 tends to rotationally swing in a leftward/rightward direction as the vehicle body 20 rolls (see FIG. 1) during turning operation of the vehicle 10. To minimize the inconvenience, the power source mount 64 and transmission mount 65 are provided above the left and right side ends (center of gravity Gc) of the power unit 50, so that tangential directions of the swinging movement of the power unit 50 are allowed to agree with the directions of the spring axis lines Sp1 and Sp2 and vertical damping axis lines Vr1 and Vr2. Such arrangements can restrain and attenuate the swinging movement of the power unit 50. As a consequence, the leftward/rightward displacement (mode) of the power unit 50 can be converted into translation movement (mode) or horizontal movement (mode) that is accompanied with no rotational movement, as will be later described in detail.

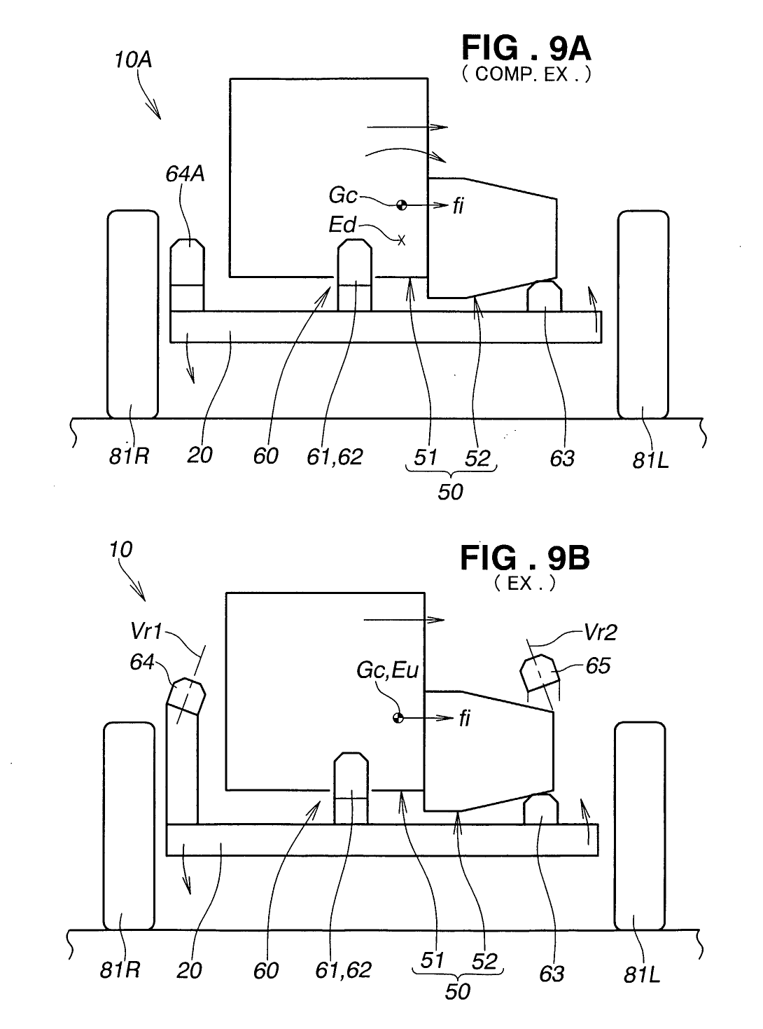

FIGS. 9A and 9B are front views, corresponding to FIG. 6, which schematically show vehicles provided with power unit support structures. More specifically, FIG. 9A shows a comparative example (“COMP. EX.”) of a vehicle 10A with a power unit support structure, while FIG. 9B shows a preferred example (“EX.”) of a vehicle 10 with the power unit support structure of the present invention.

In the power unit support structure 60 provided in the comparative example of the vehicle 10A, as illustrated in FIG. 9A, the static-load-supporting mounts 61, 62 and 63 and power source mount 64A are located lower than the center of gravity Gc of the power unit 50, and the center of composite resiliency Ed of all of the mounts 61, 62, 63 and 64A are located lower than the center of gravity Gc of the power unit 50.

As the vehicle 10A turns to the left or right, a centrifugal force acts on the turning vehicle 10A. Thus, of a plurality of suspensions (not shown) via which to support left and right road wheels 81L and 81R of the vehicle 10A, the damper and spring of one- or outer-side suspension, located outwardly of the other as viewed in the turning direction of the vehicle 10A, contract, while the damper and spring of the other or inner suspension expand. As a consequence, the vehicle body 20 is inclined in such a manner that one or outer side of the vehicle, located outwardly of the other side as viewed in the turning direction of the vehicle 10A, sinks downward while the other or inner side of the vehicle lifts upward; namely, the vehicle body 20 rolls in a clockwise/counterclockwise direction about the longitudinal axis of the vehicle body 20 passing the center of gravity.

For example, as the vehicle 10A turns to the left in its traveling direction, the vehicle body 20 rolls in the counterclockwise direction of FIG. 9A. During that time, inertia acts on the power unit 50 to make it to stay in place or maintain it in current condition, so that an inertial force fi, acting leftward or inward as viewed in the turning direction, is produced in the power unit 50. Because the center of gravity Gc of the power unit 50 is located higher than the center of composite resiliency Ed of all of the mounts 61, 62, 63 and 64A, a moment, centering about the center of resiliency Ed, acts on the power unit 50. Therefore, the power unit 50 would be displaced horizontally relative to the vehicle body 20 but also make rolling movement about the center of composite resiliency Ed; namely, the power unit 50 is placed in a coupled mode comprising the horizontal displacement and rolling movement, i.e. in a mode where the horizontal displacement and rolling movement influence each other. In order to sufficiently enhance the operating stability and riding comfort of the vehicle 10A, it is preferable to restrain the behavior of the heavy power unit 50 from influencing the vehicle body 20.

By contrast, the preferred embodiment of the power unit support structure 60 is arranged in the manner as illustrated in FIG. 9B. Namely, the vertical damping axis line Vr1 of the power source mount 64 and vertical damping axis line Vr2 of the transmission mount 65 slant, toward the longitudinal centerline (extending centrally through the width of the vehicle) to intersect with each other at the point higher than the center of gravity Gc of the power unit 50. Thus, the center of composite resiliency Eu of all of the mounts 61-65 substantially agrees with the center of gravity Gc of the power unit 50.

Therefore, as the vehicle 10 turns to the left in the traveling direction, for example, the moment resulting from the inertial force fi of the power unit 50 hardly moves, and the power unit 50 is displaced only in a generally horizontal direction without making substantial rolling movement. As a consequence, it is possible to restrain the behavior of the heavy transversal-type power unit 50 from influencing the vehicle body 20 during travel of the vehicle 10. Thus, the inventive arrangements can even further enhance the operating stability and riding comfort of the vehicle 10.

Particularly, in the preferred example, the power source mount 64 and transmission mount 65 are provided above the left and right side ends (center of gravity Gc) of the power unit 50, so that the rolling movement of the power unit 50 is allowed to agree in direction with the spring axis lines Sp1 and Sp2 and vertical damping axis lines Vr1 and Vr2. Such arrangements can even more effectively restrain or attenuate the rolling movement of the power unit 50, so that any displacement of the power unit 50 can be converted into horizontal displacement.

Further, with the simple arrangement that, as viewed from the front of the vehicle 10, the vertical damping axis lines Vr1 and Vr2 slant to intersect with each other at a point higher than the center of gravity Gc of the power unit 50, it is possible to freely set the center of composite resiliency Eu of all of the mounts at an optimal height. In setting the center of composite resiliency Eu of all of the mounts at an optimal height, the supporting heights of the power source mount 64 and transmission mount 65 can be set relatively freely, with the result that the design freedom of the vehicle can be enhanced significantly.

Furthermore, with the aforementioned static-load-supporting mounts 61, 62, 63, power source mount 64 and transmission mount 65, the power unit support structure 60 of FIG. 9B can restrain vibration of the transversal-type power unit 50 from being transmitted to the vehicle body 20.

Further, as shown in FIG. 7, i.e. as viewed from above the vehicle 10, the horizontal damping axis line Ho1 of the power source mount 64 and the horizontal damping axis line Ho2 of the transmission mount 65 are inclined with respect to the forward/rearward direction and width direction of the vehicle 10. Thus, it is possible to effectively restrain loads (including vibration) in the forward/rearward direction and width direction of the power unit 50. Therefore, when the vehicle 10 makes rolling movement, pitch motion or yaw motion, the preferred embodiment can restrain the behavior of the heavy transversal-type power unit 50 from influencing the vehicle body 20 due to inertia. As a result, the preferred embodiment can even further enhance the operating stability and riding comfort of the vehicle 10.

Further, because, as shown in FIG. 7, i.e. as viewed from above the vehicle 10, the horizontal damping axis lines Ho1 and Ho2 slant to intersect with each other at right angles, it is possible to effectively restrain loads (including vibration) in the forward/rearward direction and width direction of the power unit 50.

In the vehicle 10 of the present invention, the power unit 50 need not necessarily be accommodated in the power unit space 31 provided in a front portion of the vehicle body 20; for example, the power unit 50 may be accommodated in the power unit space 31 provided in a central or middle portion of the vehicle body 20.

Further, the power unit 50 need not necessarily be mounted on the vehicle body 20 via the front subframe 40; for example, the power unit 50 may be mounted directly on the vehicle body 20.

Furthermore, the power source 51 should not be construed as limited to an engine and may be an electric motor. The transmission 52 should not be construed as limited to a transmission and may be a mere speed reducing mechanism.

Furthermore, the power source mount 64 and transmission mount 65 should not be construed as limited to liquid seal mounts and may be two-way attenuating mechanisms having respective vertical damping axis lines Vr1 and Vr2 and horizontal damping axis lines Ho1 and Ho2 perpendicular to the vertical damping axis lines Vr1 and Vr2; for example, they may be rubber mounts.

In the power source mount 64 and transmission mount 65, the first mounting member 101 may be connected to one of the power source 51 (or transmission 52) and vehicle body 20, while the second mounting member 102 may be connected to the other of the power source 51 (or transmission 52) and vehicle body 20.

The above-mentioned inclination angles θ1 and θ2 of the vertical damping axis lines Vr1 and Vr2 and the above-mentioned inclination angles α1 and α2 of the horizontal damping axis lines Ho1 and Ho2 may be set to any suitable values; for example, they may be set such that the intersection points Pv and Ph agree with the longitudinal centerline CL or agree with a straight line passing the center of gravity Gc in parallel to the longitudinal centerline CL.

### INDUSTRIAL APPLICABILITY

The power unit support structure 60 of the present invention is suitable for use in applications where a transversal-type power unit 50, having a power source 51 and transmission 52 interconnected in a juxtaposed relation in a width direction of a vehicle, is disposed in a front or middle portion of a vehicle body 20 and where the static load of the power unit 50 are supported by static-load-supporting mounts 61-63 disposed lower than the center of gravity of the power unit 50.

1. A vehicle power unit support structure comprising:
a transversal-type power unit accommodated in a power unit space and having a power source and a transmission coupled with each other in a juxtaposed relation in a width direction of the vehicle;
static-load-supporting mounts disposed lower than a center of gravity of said power unit and supporting said power unit;
a power source mount disposed on an end portion of the power source remote from the transmission; and
a transmission mount disposed on an end portion of the transmission remote from the power source,
wherein, as viewed from a front of the vehicle, both a spring axis line of said power source mount and a spring axis line of said transmission mount are inclined to intersect with each other at a point higher than the center of gravity of said power unit.

2. A vehicle power unit support structure comprising:
a transversal-type power unit accommodated in a power unit space and having a power source and a transmission coupled with each other in a juxtaposed relation in a width direction of the vehicle;
static-load-supporting mounts disposed lower than a center of gravity of said power unit and supporting said power unit;
a power source mount disposed on an end portion of the power source remote from the transmission; and
a transmission mount disposed on an end portion of the transmission remote from the power source,
wherein, as viewed from a front of the vehicle, both a damping axis line of said power source mount and a damping axis line of said transmission mount are inclined to intersect with each other at a point higher than the center of gravity of said power unit.

3. A vehicle power unit support structure comprising:
a transversal-type power unit accommodated in a power unit space and having a power source and a transmission coupled with each other in a juxtaposed relation in a width direction of the vehicle;
static-load-supporting mounts disposed lower than a center of gravity of said power unit and supporting said power unit;
a power source mount disposed on an end portion of the power source remote from the transmission; and
a transmission mount disposed on an end portion of the transmission remote from the power source,
wherein said power source mount and said transmission mount each have a predetermined vertical damping axis line and a predetermined horizontal damping axis line perpendicular to the vertical damping axis line, and, as viewed from a front of the vehicle, the horizontal damping axis lines of said power source mount and said transmission mount are inclined with respect to a forward/rearward direction and width direction of the vehicle.

4. A vehicle power unit support structure according to claim 3 wherein, as viewed from above the vehicle, the horizontal damping axis lines of said power source mount and said transmission mount are inclined to intersect at a right angle with each other.

5. A vehicle power unit support structure according to claim 1 wherein said power source mount and transmission mount are disposed higher than the center of gravity of said power unit.

6. A vehicle power unit support structure according to claim 2 wherein said power source mount and transmission mount are disposed higher than the center of gravity of said power unit.

7. A vehicle power unit support structure according to claim 3 wherein said power source mount and transmission mount are disposed higher than the center of gravity of said power unit.
